(19) United States
(12) Patent Application Publication
(10) Pub. No.: US 2026/0107365 A1
(43) Pub. Date: Apr. 16, 2026

(54) AUTONOMOUS DEVICE REPLACEMENT

(71) Applicant: ABL IP HOLDING LLC, Atlanta, GA (US)

(72) Inventors: Alexis Boisserand, Hamden, CT (US); Frank D. Pelliccio, Guilford, CT (US); Akshaykeerti Sharma, Atlanta, GA (US); Alan David Sanders, Atlanta, GA (US)

(73) Assignee: ABL IP HOLDING LLC, Atlanta, GA (US)

(21) Appl. No.: 19/340,954

(22) Filed: Sep. 26, 2025

Related U.S. Application Data
(60) Provisional application No. 63/705,868, filed on Oct. 10, 2024.

(51) Int. Cl. H05B 47/19

(52) U.S. Cl. CPC H05B 47/19

(57) ABSTRACT

An autonomous replacement protocol implemented in a lighting control system includes synchronizing a copy or representation of settings of each of a plurality of lighting control devices via a wireless control network. The autonomous replacement protocol further includes upon powering up of a replacement device, scanning, via the replacement device for one or more networks to find the wireless control network and detect other lighting control devices. The autonomous replacement protocol further includes responsive to finding the wireless control network, transmitting a request to be provisioned to one or more of the detected other lighting control devices. The autonomous replacement protocol further includes determining at a subset or all of the lighting control devices that there is a failed device on the wireless control network. The autonomous replacement protocol further includes provisioning the replacement device based on the determination that there is the failed device on the wireless control network.

### CROSS-REFERENCE TO RELATED APPLICATIONS

This application claims priority to U.S. Provisional Ser. No. 63/705,868, filed on Oct. 10, 2024, titled “Autonomous Device Replacement,” the entire disclosure of which is incorporated by reference herein.

### TECHNICAL FIELD

The present subject matter relates to lighting control systems that may include light fixtures, controllers, sensors, and networking thereof. More specifically, the present subject matter relates to automatic techniques and systems for replacing devices in a commissioned system of light fixtures and other devices.

### BACKGROUND

Conventional wall switches and light fixtures communicate over wired lighting control systems. More recent lighting control systems are wireless; however, it is difficult to control these systems as the systems scale in size and maintenance costs are expensive.

Deployment of substantial numbers of light fixtures with associated controllers and/or sensors and networking thereof presents increasing challenges for set-up and management of the lighting system elements and network communication elements of the lighting system. Commissioning the lighting system to create a physical or logical networking map of the space in a room, building, etc. where the light fixtures are installed is a manual process.

During commissioning, installers (i.e., human beings) will often take hours or multiple days to coordinate where light fixtures are coordinated in relation to a map of the space and the applications for which the light fixtures are being controlled, such as for a networked space lighting system. After the lighting control system is commissioned, replacing failed devices, such as luminaires, light switches, and sensors to operate over lighting communication control system is cumbersome.

### SUMMARY

Replacing wireless lighting control devices in a lighting control system is time-consuming and expensive from a labor perspective. Enabling electrical contractors to replace failed luminaires, lighting drivers, or lighting controls without requiring intervention of additional personnel to commission replacement devices reduces the total install cost of a wireless lighting system. Implementing a method for a wireless lighting network to automatically provision and commission a replacement device as an exact replica of the device being replaced will significantly reduce the amount of time spent on a job site. Autonomous replacement of lighting control devices enables support staff (e.g., electrical contractors and others) to validate correct operation of the replacement device before leaving the job site.

A system, computer-readable medium, and method are described to enable replacement of failed devices previously commissioned in a wireless control network for lighting controls without user interaction once power is applied to a replacement device. Replacement devices are identified by other powered commissioned devices in the wireless control network, and the new replacement device is configured with the wireless control network and operational parameters formerly defined for a failed device being replaced.

In general, the technology relates to a system and method for automatically replacing failed devices in a wireless control network for lighting controls. One benefit of the technology is that it eliminates the need for a contractor to manually program a replacement device (such as a luminaire, wall switch, sensors, etc.) when the replacement device is added to a wireless control network.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities, and combinations particularly pointed out in the appended claims.

### BRIEF DESCRIPTION OF THE DRAWINGS

The drawing figures depict one or more implementations, by way of example only, not by way of limitations. In the figures, like reference numerals refer to the same or similar elements.

FIGS. 1-2 depict a lighting control system of networks and devices that support light commissioning/maintenance, provide a variety of lighting control and implement an autonomous replacement protocol.

FIGS. 3A-C depict a luminaire of the lighting control system of FIGS. 1-2 configured to enable the autonomous replacement protocol.

FIGS. 4A-C depict a wall switch or touch panel of the lighting control system of FIGS. 1-2 configured to enable the autonomous replacement protocol.

FIG. 5 depicts a plug load controller of the lighting control system of FIGS. 1-2 configured to enable the autonomous replacement protocol.

FIG. 6 depicts a power pack of the lighting control system of FIGS. 1-2 configured to enable the autonomous replacement protocol.

FIG. 7 is an example of operation of an autonomous replacement protocol implemented by the autonomous replacement programming with five lighting control devices.

FIG. 8 depicts a sequence diagram in which the autonomous replacement protocol implemented by the autonomous replacement programming is triggered.

FIG. 9 is a flowchart of the settings synchronization logic of the autonomous replacement protocol implemented by the autonomous replacement programming in lighting control devices.

FIG. 10 depicts the provisioning and replacement logic and a corresponding flowchart of the autonomous replacement protocol implemented by the autonomous replacement programming in a replacement device.

FIG. 11 is an autonomous replacement protocol procedure for the lighting control system of FIGS. 1-2.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The term “luminaire,” as used herein, is intended to encompass essentially any type of device that processes energy to generate or supply artificial light, for example, for general illumination of a space intended for use of occupancy or observation, typically by a living organism that can take advantage of or be affected in some desired manner by the light emitted from the device. However, a luminaire may provide light for use by automated equipment, such as sensors/monitors, robots, etc. that may occupy or observe the illuminated space, instead of or in addition to light provided for an organism. However, it is also possible that one or more luminaires in or on a particular premises have other lighting purposes, such as signage for an entrance or to indicate an exit. In most examples, the luminaire(s) illuminate a space or area of a premises to a level useful for a human in or passing through the space, e.g., of sufficient intensity for general illumination of a room or corridor in a building or of an outdoor space such as a street, sidewalk, parking lot or performance venue. The actual source of illumination light in or supplying the light for a luminaire may be any type of artificial light emitting device, several examples of which are included in the discussions below.

The term “lighting system” “or “lighting control system,” as used herein, is intended to encompass essentially any type of system that either includes a number of such luminaires coupled together and/or luminaire(s) coupled together with one or more control devices, such as wall switches, control panels, remote controls, central lighting or building control systems, or servers.

Terms such as “artificial lighting” or “illumination lighting” as used herein, are intended to encompass essentially any type of lighting that a device produces by processing of electrical power to generate the light. A luminaire for an artificial lighting or illumination lighting application, for example, may take the form of a lamp, light fixture, or other luminaire arrangement that incorporates a suitable light source, where the lighting device component or source(s) by itself contains no intelligence or communication capability. The luminaire may contain a driver or control device that has intelligence and/or communications capability. Alternately, a non-intelligent luminaire may be electrically coupled to an intelligent load control device that is capable of processing communications from the lighting system. The illumination light output of an artificial illumination type luminaire, for example, may have an intensity and/or other characteristic(s) that satisfy an industry acceptable performance standard for a general lighting application.

The term “coupled” as used herein refers to any logical, physical, electrical, or optical connection, link or the like by which electricity, power, signals, or light produced or supplied by one system element are imparted to another coupled element. Unless described otherwise, coupled elements or devices are not necessarily directly connected to one another and may be separated by intermediate components, elements, or communication media that may modify, manipulate or carry the electricity, power, signals, or light.

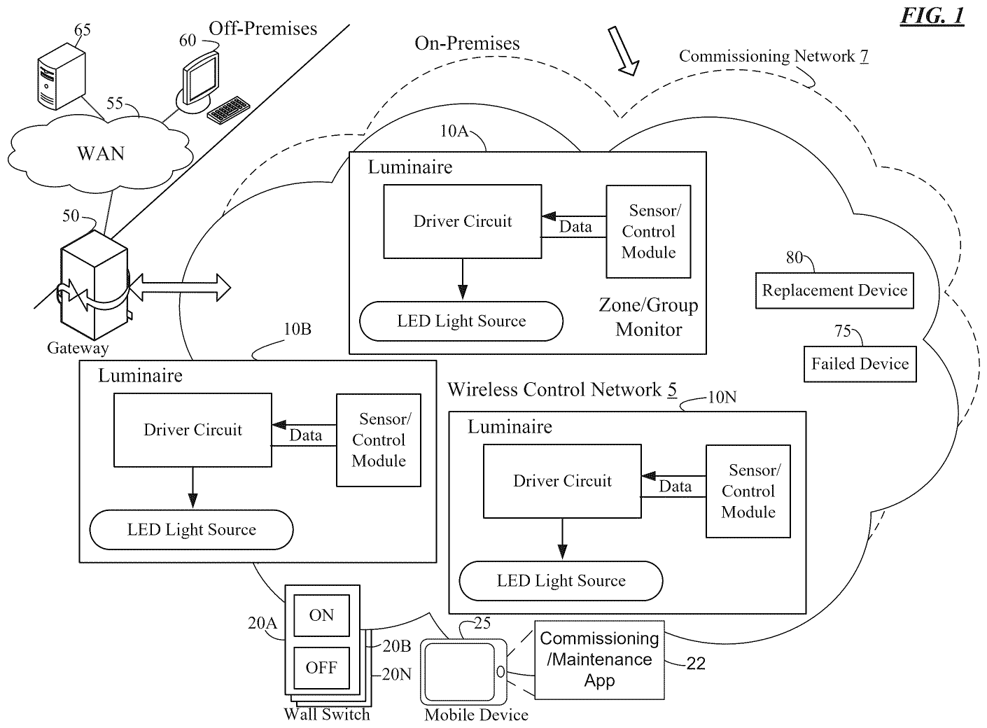

Unless otherwise indicated, any embodiment can be combined with any other embodiment. In particular, FIGS. 1-11 and the associated text are all combinable with each other. Reference now is made in detail to the examples illustrated in the accompanying drawings and discussed below.

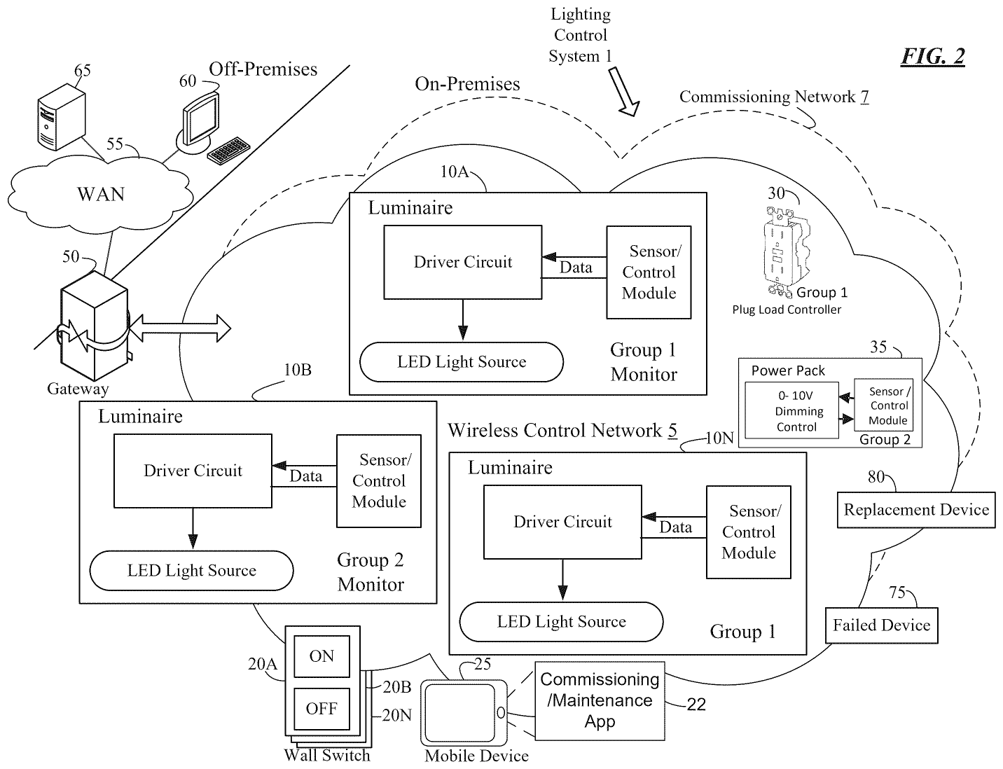

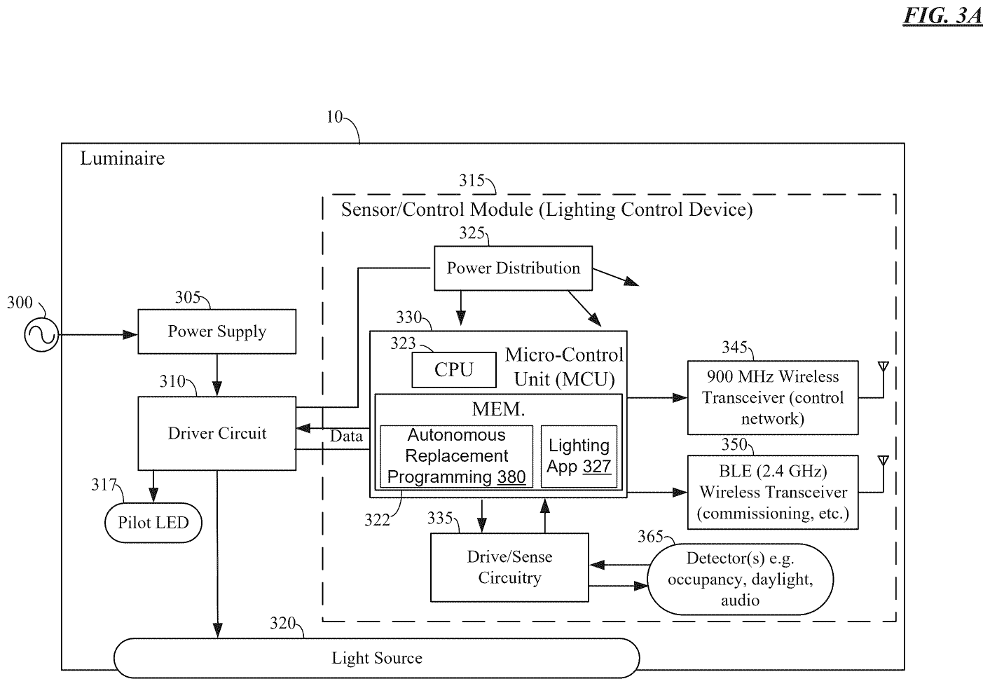

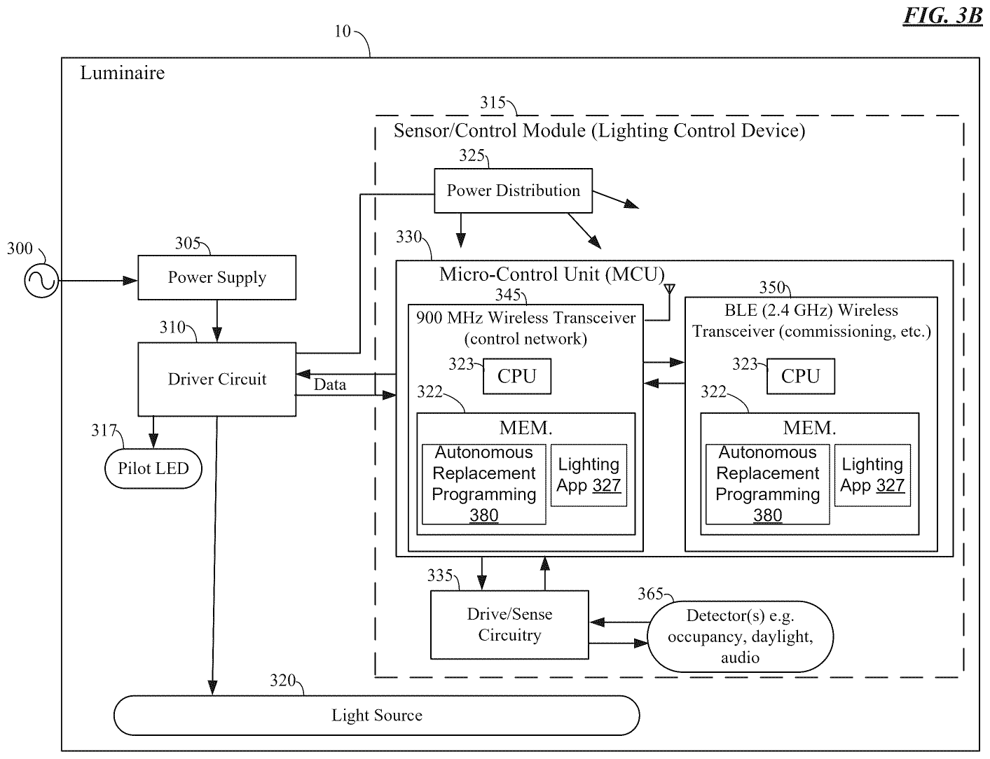

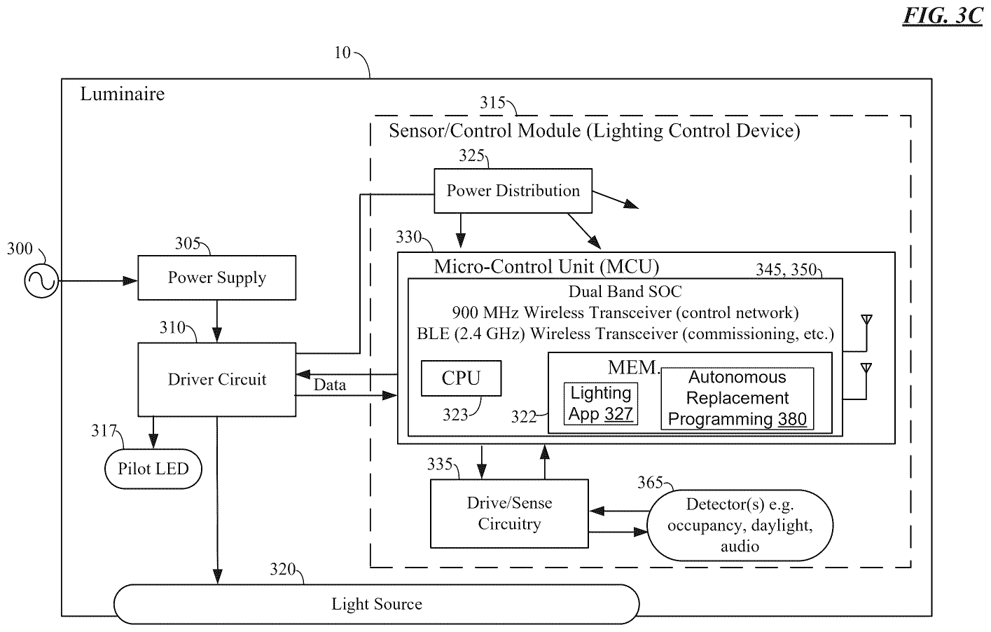

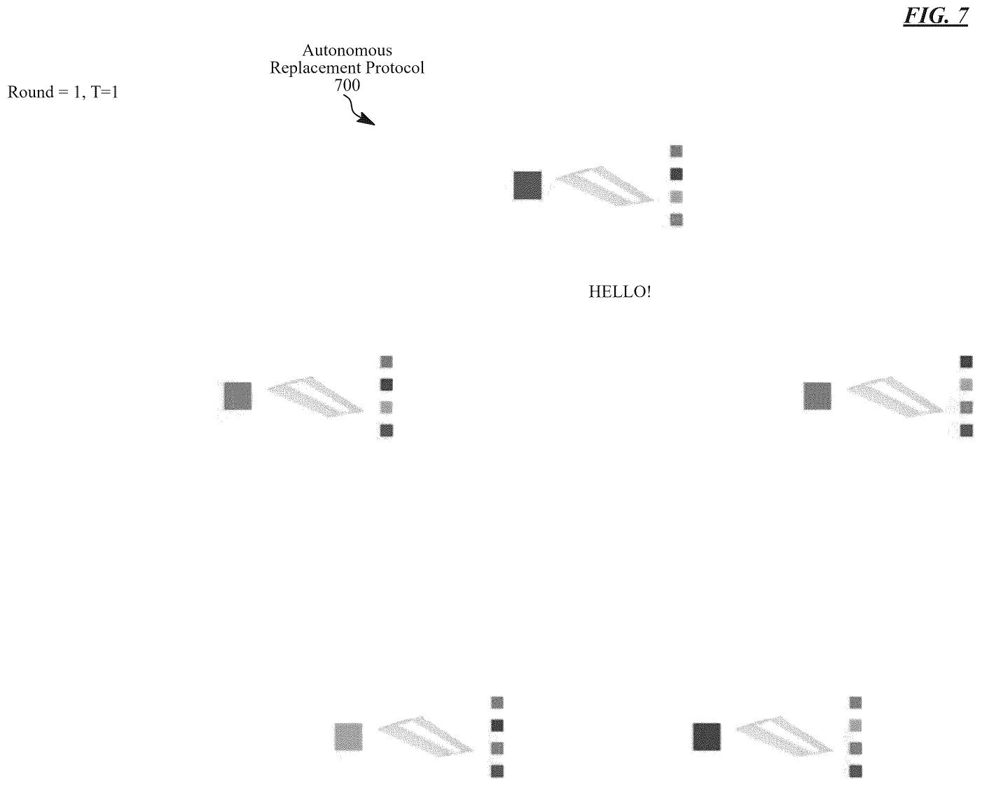

FIGS. 1-2 both illustrate functional block diagrams of an example of a lighting control system 1 of networks 5, 7 and devices 10A-N, 20A-N, 25, 30, 35 that support light commissioning/maintenance and provide a variety of lighting control, including communications in support of turning lights on/off, dimming, set scene, and sensor trip events. The lighting control system 1 implements an autonomous replacement protocol 700 (see FIGS. 7-11) FIG. 2 is the same as FIG. 1 but further includes additional lighting control devices (LCDs): a plug load controller 30 and a power pack 35; and illustrates exemplary lighting control groups. It should be understood that the term “lighting control device” means a device that includes a controller (sensor/control module or micro-control unit) as shown in FIGS. 3A-C, 4A-C, 5, and 6 that executes a lighting application for communication over a wireless lighting control network communication band, of control and systems operations information during control network operation over the lighting control network communication band.

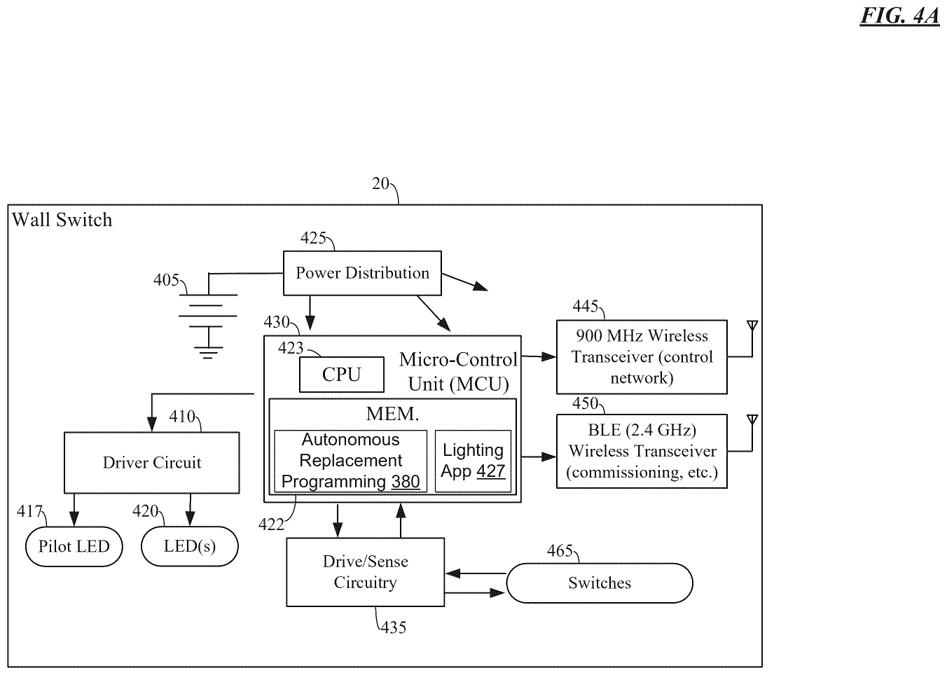

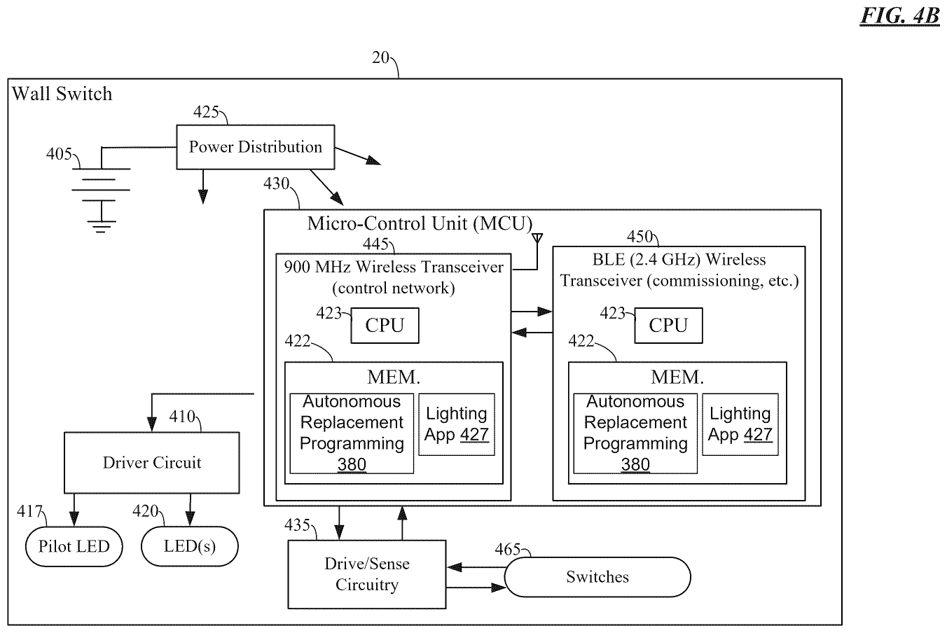

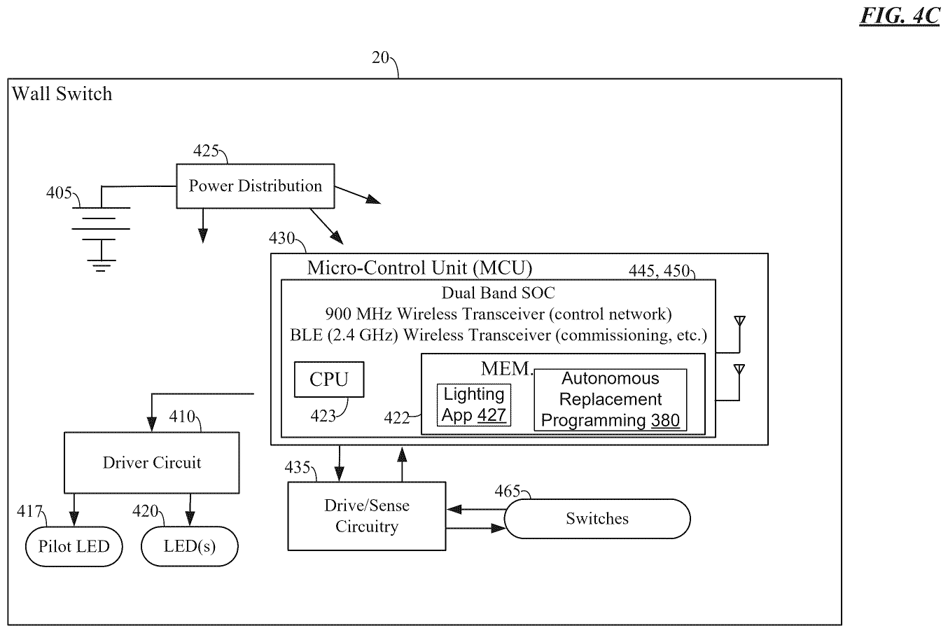

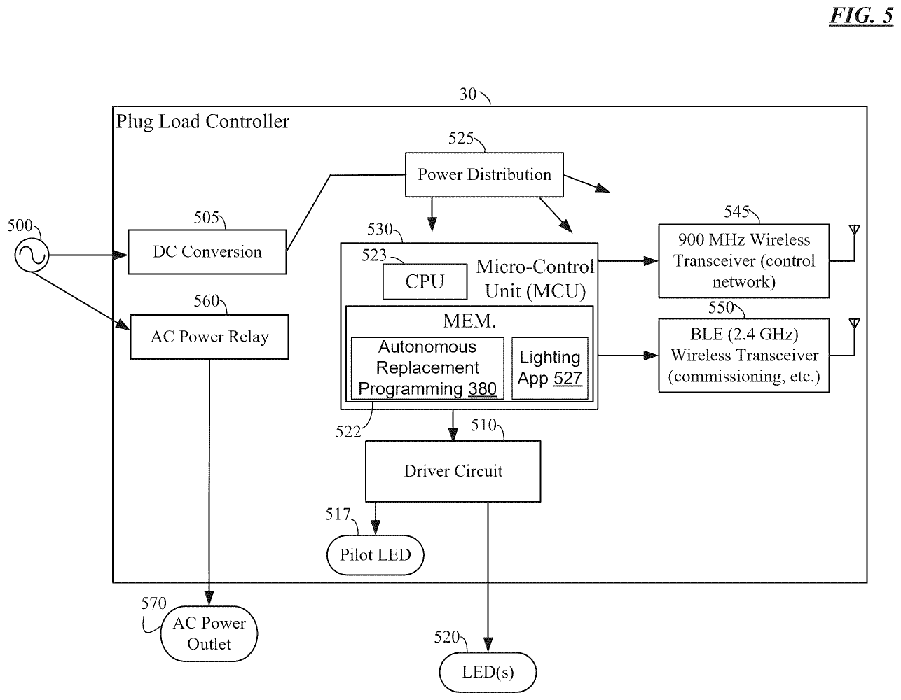

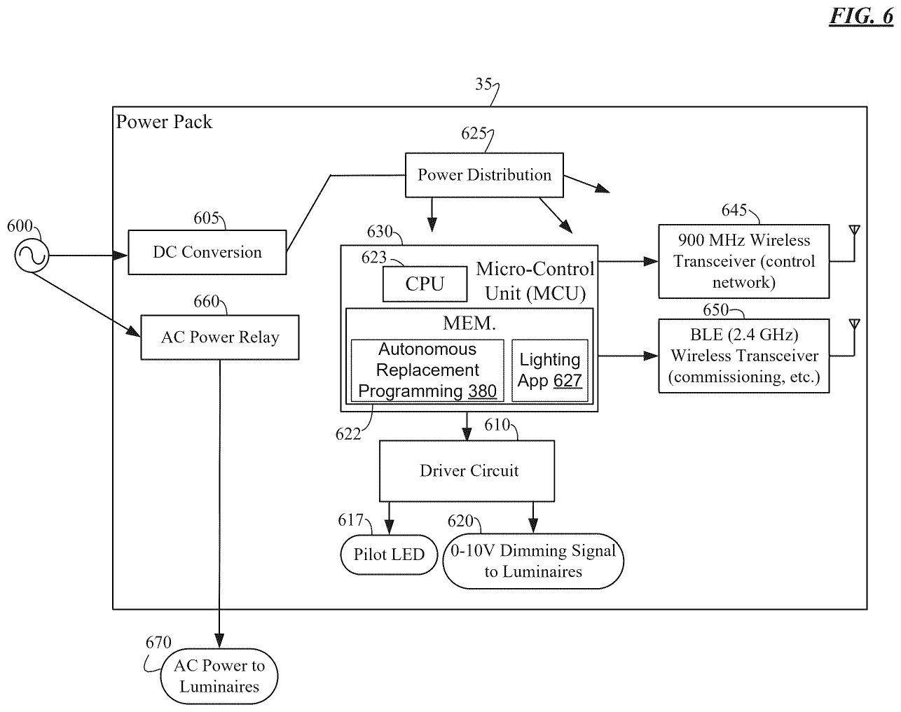

For example, a luminaire 10 (FIGS. 3A-C) that includes a sensor/control module 315 having a micro-control unit 330 that executes lighting application 327 is a lighting control device. A wall switch 20 or touch panel 20 (FIGS. 4A-C) that includes a sensor/control module 415 having a micro-control unit 430 that executes lighting application 427 is a lighting control device. A plug load controller 30 (FIG. 5) that includes a micro-control unit 530 that executes lighting application 527 is a lighting control device. A power pack 35 (FIG. 6) that includes a micro-control unit 630 that executes lighting application 627 is a lighting control device. The luminaire 10, wall switch 20, plug load controller 30, power pack 35, failed device 75, and replacement device 80 are configured to enable the autonomous replacement protocol 700 via autonomous replacement programming 380.

The lighting control system 1 may be designed for indoor commercial spaces. As shown, lighting control system 1 includes a variety of lighting control devices, such as a set of luminaires 10A-N (lighting fixtures) and a set of wall switches 20A-N. Daylight, occupancy, and audio sensors are embedded in lighting control devices, in this case luminaires 10A-N to enable controls for occupancy and dimming.

Luminaires 10A-N, wall switches 20A-N, plug load controller 30, and power pack 35 communicate control over a 900 MHz (sub-gigahertz) wireless control network 5 and accordingly each include a first radio in the sub-gigahertz range. In some examples, a radio frequency (RF) band in a different range can be used, for example, any suitable RF frequency band. A variety of controls are transmitted over wireless control network 5, including, for example, turn lights on/off, dim up/down, set scene (e.g., a predetermined light setting), and sensor trip events. Each luminaire 10A-N, wall switch 20A-N, plug load controller 30, and power pack 35, is also equipped with a second near range Bluetooth Low Energy® (BLE®) radio that communicate over commissioning network 7 for purposes commissioning and maintenance the wireless lighting control system 1, however no controls pass over this commissioning network 7.

Plug load controller 30 plugs into existing AC wall outlets, for example, and allows existing wired lighting devices, such as table lamps or floor lamps that plug into a wall outlet, to operate in the lighting control system 1. The plug load controller 30 instantiates the table lamp or floor lamp by allowing for commissioning and maintenance operations and processes wireless lighting controls in order to the allow the lighting device to operate in the lighting control system 1.

Power pack 35 retrofits with existing wired light fixtures (luminaires). The power pack 35 instantiates the wired light fixture by allowing for commissioning and maintenance operations and processes wireless lighting controls in order to allow the lighting device to operate in the lighting control system 1.

Both plug load controller 30 and power pack 35 can include the same circuitry, hardware, and software as light fixtures 10A-N and wall switches 20A-N.

The lighting control system 1 is provisioned with a mobile device 25 that includes a commissioning/maintenance application 22 for commissioning and maintenance functions of the lighting control system 1. For example, mobile device 25 enables mobile commissioning, configuration, and maintenance functions and can be a PDA or smartphone type of device with human interfacing mechanisms sufficient to perform clear and uncluttered user directed operations. Mobile device 25 runs mobile type applications on iOS, Android, and Windows operating systems and commissioning/maintenance application 22 to support commissioning.

Web enabled (cloud) services for facilitating commissioning and maintenance activities is also provided by mobile device 25. The commissioning/maintenance application 22 of commissioning mobile device 25 interfaces with the cloud services to acquire installation and configuration information for upload to luminaires 10A-N, wall switches 20A-N, plug load controller 30, and power pack 35. The installation and configuration information is received by mobile device 25 from the gateway 55. The gateway 50 engages in communication through the wide area network (WAN) 55.

Lighting control system 1 can leverage existing sensor and fixture control capabilities of Acuity Brands Lighting's commercially available nLight® wired product through firmware reuse. In general, Acuity Brands Lighting's nLight® wired product provides the lighting control applications. However, the illustrated lighting control system 1 includes a communications backbone and includes model-transport, network, media access control (MAC)/physical layer (PHY) functions. The sub-gigahertz communications of the wireless control network 5 features are built on a near 802.15.4 MAC and PHY implantation with network and transport features architected for special purpose control and air time optimizations to limit chatter. Although a sub-gigahertz band is used in the example wireless control network 5, any RF communication band can be used for the wireless control network 5.

The lighting control system 1 can be deployed in standalone or integrated environments. Lighting control system 1 can be an integrated deployment, or a deployment of standalone groups with no gateway 50. One or more groups of lighting control system 1 may operate independently of one another with no backhaul connections to other networks.

Lighting control system 1 may comprise a mix and match of various indoor systems, wired lighting systems (nLight® wired), emergency, and outdoor (dark to light) products that are networked together to form a collaborative and unified lighting solution. Additional control devices and lighting fixtures, gateway(s) 50 for backhaul connection, time sync control, data collection and management capabilities, and interoperation with the Acuity Brands Lighting's commercially available SensorView product may also be provided.

As shown in FIG. 2, control, configuration, and maintenance operations of the lighting control system 1 involve networked collaboration between the luminaires 10A-N, wall switches 20A-N, plug load controller(s) 30, and power pack(s) 35 that comprise a lighting control group. An installation is comprised of one or more lighting control groups each operating independently of one another. One or more lighting control groups may exist in the wireless control network 5. Each lighting control group will have a group monitor, and this is shown in FIG. 2 where there are two groups and each group has a monitor.

Groups are formed during commissioning of the lighting control system 1 where all members of the group are connected together over wireless control network 5, which in our example is a sub-gigahertz subnetwork defined by an RF channel and a lighting control group identifier. Of course, other RF frequencies can be used.

The lighting control devices subscribe to channels and only listen for/react to messages on the RF channel with the identifier (ID) of the subscribed channel that designates the lighting control group that the lighting control device is a member of. For example, the lighting control devices subscribe to a multicast group as identified by the lighting control group identifier and only react to messages on the RF channel of the lighting control group.

A group can be further divided to address control to specific control zones within the group defined by a control zone identifier. Zone communications are managed as addressable features at run time. Up to 16 independent zones of control are available for each group and each group can support up to 128 addressable elements (luminaires 10A-N, wall switches 20A-N, plug load controller 30, power pack 35).

The wireless control network 5 distributes control messages and events, network management messages and events, health, and failover events, and group commissioning and maintenance communications, such as firmware update distributions and group membership changes.

Wireless control network 5 provides a secure control network (e.g., sub-gigahertz) on which to operate. Devices are manually added to the wireless control network 5 via the commissioning process via commissioning/maintenance application 22 of mobile device 25. The commissioning process includes authorization and authentication features that allow only trusted and known entities to add confirmed devices 10A-N, 20A-N, 30, 35, 75 to the wireless control network 5. Requirements relating to network modification (device add/delete/modify) are allocated to the mobile device 25 and its interface (commissioning/maintenance application 22) to the lighting control system 1.

Message authentication in the lighting control system 1 is provided by the 802.15.4 compliant MAC layer solution commercially available from Silicon Labs. The solution uses the AES CCM block cypher mode of operation to secure over the air frames. The mode of operation provides NIST compliant authentication, encryption, and integrity assurance to defeat replay attacks as well as device and message spoofing.

Lighting control system 1 also implements an additional layer of authentication by performing checks on the message source and addressing mechanisms to reject messages from unknown sources (i.e., sources that are not authorized members of a lighting control group network). An intrusion detection scheme using the above schemes and that reports such events will be made via the gateway 50.

The example sub-gigahertz MAC/PHY (wireless control network 5) thus provides secure communication features (authentication, data integrity, and encryption assurance) based on the 802.15.4 standard.

The lighting control devices over the wireless control network 5 together may engage in any-to-many (unicast and multicast) communications and can implement a non-mesh wireless network topology. In our example, wireless control network 5 is a star topology network. Although other network schemes may be utilized, a star topology may be the best fit for aligning the required control communications features with the characteristics of the example sub-gigahertz wireless radio. At the center of each lighting control group in a star topology wireless control network 5 is a singular group monitor as shown in FIG. 2. In FIG. 2, luminaire 10A is the group monitor for lighting control group 1 and luminaire 10B is the group monitor for lighting control group 2. Lighting control group 1 further comprises luminaire 10N, wall switch 20A, and plug load controller 30. Lighting control group 2 further comprises wall switch 20B and power pack 35.

The group monitor is responsible for receiving control events from their source (luminaires 10A-N, wall switches 20A-N, plug load controller 30, and power pack 35) and ensuring reliable and timely delivery of the event to the other members of the group. The monitor uses a quick best effort multicast mechanism for fast high-probability delivery. The monitor follows up the multicast with a reliable point to point communication to ensure that all destination devices received the event.

### Commissioning

Commissioning is the process that sets the lighting control configuration and settings that drive the behavior of the lighting control system 1. One or more mobile devices 25 can be used to commission the installation of lighting control system 1. During setup, commissioning/maintenance application 22 of the mobile device 25 provides a secure method for a system installer to configure the lighting control devices (LCDs) for installation commissioning. The lighting control devices include luminaires 10A-N, wall switches 20A-N, plug load controller 30, and power pack 35.

General behavioral settings and network addressing information are stored on the mobile device 25 for upload and allocation to the installation's lighting control devices via commissioning/maintenance application 22. The installation information is managed by commissioning/maintenance application 22 of mobile device 25 to ensure correctness and to eliminate common errors such as assignment of duplicate network addresses.

Communication between the mobile device 25 for commissioning/maintenance and the lighting control devices is over the commissioning network 7, such as a BLE® network. The lighting control devices are initially in an installation state, beaconing their advertisements when the commissioning starts.

Upon connection with the mobile device 25, the commissioning/maintenance application 22 of mobile device 25 transitions the lighting control devices to a commissioning state. Further upon connection, the lighting control device authenticates the mobile device 25 and is ready to accept commands over the commissioning network 7. The wall switches 20A-N suppress sleep mode until completion of the commissioning process and transition to operational mode. Wall switches 20A-N will re-enter sleep mode if the commissioning process is interrupted—two elapsed hours with no activity.

An installation is commissioned according to lighting control groups. A group is a collection of LCDs sharing the same space within an installation (e.g. a room or area). Each lighting control group in the installation has a special lighting control device called the group monitor. The group monitor keeps tabs on the overall state and health of the lighting control devices within the group and assists in the communication of lighting control events between group elements. In general, one can visualize the group network topology as a star with the group monitor as the central node and the remainder of the group's lighting control devices at points of the star.

A group is commissioned by first establishing the group's lighting control network 5 and then configuring the group's control behavior. The lighting control network 5 is established over an 802.15.4 based MAC riding on top of an example sub-gigahertz (904 MHz to 926 MHz) PHY. The commissioning network 7, such as a Bluetooth® Low Energy MAC/PHY, is used too as the point to point connection medium to transfer control network configuration from the commissioning/maintenance application 22 of the mobile device 25 to a lighting control device The commissioning/maintenance application 22 of mobile device 25 builds a network table of the group devices while establishing the lighting control network 5. The network table, used by the group monitor in the execution of its responsibilities, is uploaded from the mobile device 25 to the group's lighting control devices via commissioning/maintenance application 22.

Each lighting control device also has a behavioral configuration. The configuration is specified by a group of settings that define control characteristics such as sensor set points, delays, modes, and ranges. The control characteristics also specify independent zones of control within the group. These characteristics and settings are customized as necessary and uploaded from the mobile device 25 to each lighting control device via commissioning/maintenance application 22.

During the commissioning process, line powered lighting control devices are installed, powered, and advertising over BLE®. Battery powered lighting control devices, such as wall switches 20A-N, are installed and in sleep mode to conserve power. After the mobile device 25 is set up, an installer opens the commissioning/maintenance application 22 on the mobile device 25 and walks into an area of the installation that is ready to commission as a lighting control group.

In commissioning, the lighting control devices 10A-N, 20A-N, 30, 35, 75 are provisioned with network characteristics. The commissioning/maintenance application 22 generates network keys and establishes network characteristics and configures the lighting control devices 10A-N, 20A-N, 30, 35, 75. For example, the network characteristics can include a frequency/channel (0-11), a personal area network (PAN) identifier, security keys, and a local lighting control group (e.g., a group table of 1-128 devices). Operational characteristics (e.g., settings/behaviors) are also configured by the commissioning/maintenance application 22, for example, broadcast channel(s), tracking channel(s), time delays, etc.

### Autonomous Device Replacement

Autonomous device replacement enables failed lighting control devices 10A-N, 20A-N, 30, 35 that were previously commissioned to be automatically replaced without any additional user intervention or software configuration on the commissioning network 7. The autonomous device replacement self-heals a wireless control network 5 of wireless lighting control devices 10A-N, 20A-N, 30, 35 that were previously commissioned in the wireless control network 5. The failed device 75 can include luminaires 10A-N, wall switches 20A-N, plug load controller 30, and power pack 35. Enabling electrical contractors to replace failed luminaires or driver circuits without requiring intervention from additional personnel to commission replacement devices reduces the total install cost of the wireless lighting control system 1.

Implementing an autonomous replacement protocol 700 for the lighting control system 1 to automatically provision and commission a replacement device 80 as an exact replica of a failed device 75 for lighting control that is being replaced significantly reduces the amount of time spent on-premises at a job site. The autonomous replacement protocol 700 enables support staff (e.g. electrical contractors and others) to validate correct operation of the replacement device 80 before leaving the premises, particularly the job site.

Autonomous replacement programming 380 implements the autonomous replacement protocol 700. The autonomous replacement programming 380 can be loaded as firmware in the lighting control devices 10A-N, 20A-N, 30, 35, 75, 80 and implement the following functions. There is a wireless control network 5 of lighting control devices 10A-N, 20A-N, 30, 35, 75 that are commissioned in the lighting control system 1. Once all devices are commissioned, the devices 10A-N, 20A-N, 30, 35, 75 start the synchronization phase where the devices 10A-N, 20A-N, 30, 35, 75 start exchanging settings with each other. After the end of synchronization, all of the devices 10A-N, 20A-N, 30, 35, 75 have copies of the settings of other devices. Then, at some point, if a failed device 75 of the lighting control devices 10A-N, 20A-N, 30, 35, 75 is no longer communicating and goes missing, then a technician comes with a new replacement device 80 for the failed device 75 and powers on the replacement device 80 and the replacement device 80 scans surroundings for existing networks.

The autonomous replacement programming 380 distributes and synchronizes settings of the lighting control devices 10A-N, 20A-N, 30, 35, 75. For example, all lighting control devices 10A-N, 20A-N, 30, 35, 75 store a list of settings for other lighting control devices 10A-N, 20A-N, 30, 35, 75, including: (1) network address; (2) device type; (3) device settings; and (4) a frame counter. The lighting control devices 10A-N, 20A-N, 30, 35, 75 can periodically transmit the settings or a representation of the settings, such as a code or value of the settings. For example, the lighting control devices 10A-N, 20A-N, 30, 35, 75 can periodically broadcast the representation of the settings, such as cyclic redundancy checks (CRCs) or hashes of all settings. Meaning, instead of constantly sharing all settings, a shorter representation, such as a code or value, including a CRC or hash, can be shared and the settings requested if there is a change to the representation of the settings, such as the CRC or hash. If the representation of the settings, such as CRC or hash, mismatches a local cache on another device, the other device can request more details and update the local copy of the settings. A source lighting control device 10A-N, 20A-N, 30, 35, 75 broadcasts all settings and configuration information to the lighting control group, including: (1) sub-gigahertz network address (e.g., 16 bits); (2) settings in key-value pair format; and (3) trigger effects table. The recipient lighting control devices 10A-N, 20A-N, 30, 35, 75 store the peer device settings in non-volatile memory 322, 422, 522, 622. Any suitable RF band can be used in lieu of a sub-gigahertz band.

Whenever the replacement device 80 finds the wireless control network 5 around, the replacement device 80 reaches out to some of the devices 10A-N, 20A-N, 30, 35 that are detected and requests to be provisioned. The replacement device 80 sends a message requesting provisioning and checks whether there is a missing failed device 75 in the wireless control network 5 that died and corresponds to the same type as the replacement device 80. Replacement device 80 can be verified to be of the same type of the failed device 75, for example, by checking a device identifier. If that is the case, the new replacement device 80 will be provisioned so that all of the settings of the wireless control network 5 are transferred to the replacement device 80 that were on the failed device 75 so that the replacement device 80 can join the wireless control network 5. Once the replacement device 80 has joined the wireless control network 5, the other devices 10A-N, 20A-N, 30, 35 send a copy of the settings (e.g., network address) of the failed device 75 so the replacement device 80 has the same settings (e.g., network address) of the failed device 75 that died.

Settings that are transcribed to the replacement device 80 can include all of the configuration information of the failed device 75: (1) network provisioning information; (2) logical grouping; (3) network address; (4) product type (device identifier or device type); (5) behavioral settings (occupancy time delay, output level for a preset number). There are a number of settings that characterize the behavioral settings of a particular type of device 10A-N, 20A-N, 30, 35, 75). All of those behavioral settings are distributed to all of the other devices 10A-N, 20A-N, 30, 35 on the wireless control network 5 and any of those devices 10A-N, 20A-N, 30, 35 can be used to restore the behavioral settings of that original failed device 75 once the replacement device 80 joins the wireless control network 5. To the rest of the wireless control network 5 and other devices 10A-N, 20A-N, 30, 35, the replacement device 80 will appear as the original failed device 75 in every way.

Determining whether one of the devices 10A-N, 20A-N, 30, 35, 75 has died and is a failed device 75 can be implemented as follows. Once all of the settings are synchronized and the wireless control network 5 works normally, each of the devices 10A-N, 20A-N, 30, 35, 75 sends a message to each other. Each device 10A-N, 20A-N, 30, 35, 75 is assigned a time slot and each device 10A-N, 20A-N, 30, 35, 75 sends a message periodically in round robin fashion so the device 10A-N, 20A-N, 30, 35, 75 knows when the other device should be sending a message if the other device were alive. In this message that the device 10A-N, 20A-N, 30, 35, 75 sends, there is a bitmap that tells the other devices which devices that device 10A-N, 20A-N, 30, 35, 75 considers offline. So, each device 10A-N, 20A-N, 30, 35, 75 tells the other devices 10A-N, 20A-N, 30, 35, 75 which devices the device 10A-N, 20A-N, 30, 35, 75 considers offline. Whenever all of the devices 10A-N, 20A-N, 30, 35 on a wireless control network 5 consider a particular lighting control device 75 offline after a given number of rounds, then the particular lighting control device 75 is a failed device 75 and fit for replacement. The consensus among peer devices 10A-N, 20A-N, 30, 35 can be done at a lighting control group level.

The autonomous replacement programming 380 enables service personnel to go to a site and replace a failed device 75 without use of software tools that require special training and authorization. An electrical contractor who does not have experience with tools and training with the commissioning/maintenance application 22 on the mobile device 25 can go in and install the replacement device 80 The electrical contractor can then validate the correct behavior making the replacement operation less costly and more efficient.

The verification that the replacement device 80 has successfully replaced the failed device 75 in the lighting control group and on the wireless control network 5 can include a confirmation step. The confirmation step validates that the replacement device 80 is connected and online and will operate as the failed device 75 previously did in the lighting control group on the wireless control network 5. The confirmation step may vary depending on the device type. In a first example, if the type of the failed device 75 is an output device, such as a luminaire 10, that is controlled by switches 465, then after the failed device 75 is changed out, the replacement device 80 (luminaire 10) should be controllable by the same wall switch 20. The same wall switch 20 should be able to turn the replacement device 80 on/off. That is the confirmation that the luminaire was 10 a successful replacement. If the replacement device 80 is a sensor/control module 315, such as an occupancy detector 365, the electrician can waive a hand in front and see if the luminaire 10 is connected to the sensor/control module 315 and the sensor/control module 315 should actually turn the luminaire 10 on/off. For a user interface device, such as a touch control panel, confirmation can occur by controlling a luminaire 10 connected to the control panel and turning the luminaire 10 on/off. Confirmation can also occur by having an illumination pattern blink/flash several times on an output device, such as a pilot LED 317, 417, 517, 617 to indicate the replacement was successful, such as on the pilot LED 317 of a luminaire 10.

During the autonomous replacement protocol 700 implemented by the autonomous replacement programming 380, a lighting control group of lighting that communicates on the wireless control network 5 can be self-healing. The autonomous replacement programming 380 can replace one type of device with the same type of device to keep the lighting control system 1 for lighting controls behaving the same as it did previously. At the same time, the autonomous replacement programming 380 avoids having maintenance personnel needing to be familiar with and have access to the commissioning/maintenance application 22.

The electrician or other technician no longer needs to carry a mobile device 25, such as a tablet or other device, with the loaded commissioning/maintenance application 22 to replace the failed device 75. This simplifies maintenance of the lighting control system 1 by an electrician without requiring software tools. In previous systems, typically two persons are sent on-premises at a job site for replacement: an electrical contractor and a service personnel that needs to be familiar with the lighting control system 1, software maintenance procedures, and that has access to a mobile device 25 with the commissioning/maintenance application 22. With the autonomous replacement protocol 700 implemented by the autonomous replacement programming 380, elimination of an extra service personnel is achieved. Therefore, no software interface is needed to bring up the replacement device 80 and perform a substitution of the failed device 75.

### Decentralized Polling

In order to copy the settings of a missing failed device 75 to the replacement device 80, some mechanism is required to store and reassemble the settings of the missing failed device 75 on the replacement device 80. A settings change is also detected, and the network copy can be synchronized with the replacement device 80.

Besides, the wireless control network 5 is able to detect whenever a lighting control device 10A-N, 20A-N, 30, 35, 75 goes missing. Any lighting control device 10A-N, 20A-N, 30, 35, 75 can stop working, including the group monitor, therefore it is important that all the devices 10A-N, 20A-N, 30, 35, 75 have the same role in regard to this mechanism.

Decentralized polling serves these two purposes by: (1) making sure that all lighting control devices 10A-N, 20A-N, 30, 35, 75 carry an up-to-date copy of the settings of all the other ones; and (2) detecting the absence of any lighting control device 10A-N, 20A-N, 30, 35, 75.

During operation, all line-powered lighting control devices 10A-N, 20A-N, 30, 35, 75 periodically send a “Hello” packet in a round-robin fashion. This packet can contain the settings or a representation of the settings, such as five different 32-bit CRCs or hashes, calculated over: (1) default settings; (2) master settings; (3) global settings; (4) a trigger effect table; and (5) preset scene tokens. Identification of a failed lighting control device 10A-N, 20A-N, 30, 35, 75 requires consensus among peer lighting control devices 10A-N, 20A-N, 30, 35, 75. The lighting control devices 10A-N, 20A-N, 30, 35, 75 send messages out periodically, in a round-robin fashion, to identify themselves as being online in the wireless control network 5. The order in the round is defined by a pre-shared list of all the lighting control devices 10A-N, 20A-N, 30, 35, 75 in a particular group (called lighting control group table) which is pushed to all the devices 10A-N, 20A-N, 30, 35, 75 as part of the provisioning process by the commissioning/maintenance application 22. Other network lighting control devices 10A-N, 20A-N, 30, 35, 75 keep track of which device it has seen or not, during the current round. Other network devices 10A-N, 20A-N, 30, 35, 75 can periodically report a 128-bit bitmap, indicating that device's assessment of which devices 10A-N, 20A-N, 30, 35, 75 are online (have seen a recent message) on the wireless control network 5 or offline (have not seen a recent message for more than X rounds) from all other network devices 10A-N, 20A-N, 30, 35, 75. All network devices 10A-N, 20A-N, 30, 35, 75 periodically transmit their 128-bit bitmap. All network devices 10A-N, 20A-N, 30, 35, 75 use this periodic message as a consensus check. All other network devices 10A-N, 20A-N, 30, 35 must agree when they have marked a failed device 75 as having been offline. After n-number of unchanged consensus check status messages, lighting control devices 10A-N, 20A-N, 30, 35 can agree that a particular failed device 75 is truly offline.

The representation of the settings, such as CRCs or hashes, are used by other lighting control devices 10A-N, 20A-N, 30, 35 to determine whether they have the latest copy of settings of the failed device 75. The packet also contains a 128-bit bitmap indicating which of the lighting control devices 10A-N, 20A-N, 30, 35, 75 are considers offline, such as the failed device 75.

Each lighting control device 10A-N, 20A-N, 30, 35, 75 is assigned a specific time slot at which it is expected to send its packet, based on its position in the lighting control group table. Because all devices share the same copy of the lighting control group table, each device knows exactly its position in the round as well as others' positions.

The time at which the packet is sent is defined as t⁰+<device's index>* HELLO_INTERVAL* where t⁰ coincides with the end of the previous round.

To make sure the lighting control devices 10A-N, 20A-N, 30, 35, 75 remain synchronized, each device updates its “send Hello packet” timer every time it receives a “Hello” packet from another device:
t “send next Hello”=<now>+dist(<source's index>, <device's index>)*HELLO_INTERVAL

Where dist(x, y) is the distance from x to y when going in the clockwise direction in the round.

When a device joins the round, it first waits at most a whole round listening to potential other “Hello” packets, so that it can synchronize its clock with the rest of the network.

### Settings Synchronization

The destination address of the “Hello” packet keeps changing, also in a round-robin fashion, starting with the next lighting control device 10A-N, 20A-N, 30, 35, 75 node in the group table. Battery-powered devices are skipped.

When a node receives a “Hello” packet, it checks if the copy of settings or representation of the settings, such as CRCs or hashes, match, if they do not and if the destination address corresponds to its own address, it starts the synchronization by querying only what's mismatching. If the other nodes on the network (which address does not match the destination) also detected a mismatch, they will listen to the responses in which they are interested to also update their own copy of the settings. As a result, in the best case scenario, each lighting control device 10A-N, 20A-N, 30, 35, 75 needs to communicate its settings only once to the rest of the wireless control network 5.

Because the destination address keeps changing, each device gets an opportunity to drive the synchronization and make sure its copy is in sync with the source.

FIG. 7 is an example of operation of an autonomous replacement protocol 700 implemented by the autonomous replacement programming 380 with five lighting control devices 10A-N, 20A-N, 30, 35. Any of the lighting control devices 10A-N, 20A-N, 30, 35 can potentially drive the synchronization by querying all the settings that do not match with a local copy of the settings.

With the autonomous replacement protocol 700, the electrical contractor is not using the commissioning/maintenance application 22. There is no software application so now the electrical contractor can just go on-premises in the space and swap out a failed device 75 with a replacement device 80. Again, there is no software intervention at all, there are no specialized tools or software applications needed for the replacement device 80 to work as the autonomous replacement programming 380 works automatically. The electrical contractor who is not skilled with the lighting control system 1 or commissioning/maintenance application 22 can just go on-premises to the space and swap out the failed device 75 for the replacement device 80 and the replacement device 80 will assume the behaviors of the prior failed device 75. There are no software tools or additional skills required to make the swap.

The time between t^{N} and t^{N}+1, called t^{HELLO_INTERVAL} is constant and a full round takes number of devices*^{tHELLO_INTERVAL} to complete.

### Missing Device Detection

When no packet is received from some lighting control device 10A-N, 20A-N, 30, 35, 75 for more than MISSED_ROUNDS_THRESHOLD*, all devices start sending “Hello” packets with the bit corresponding to the index of this device in the group table set to 1. * remains to be defined. Not necessarily constant, it could be defined as a function of the number of devices in the group, so that the time to detect a missing device remains constant independently of the size of the group.

To ensure that the whole network is in agreement, a failed device 75 is only considered missing (i.e. a fit for replacement), if after BITSET_ROUNDS_THRESHOLD* rounds, all the other “Hello” packets received from the other lighting control devices 10A-N, 20A-N, 30, 35 also have the corresponding bit set to 1 in their “Hello” packet. Note that it is not expected that all the other lighting control devices 10A-N, 20A-N, 30, 35 are in agreement, but that all the lighting control devices we got a vote from (“hello” packet) are.

Even though the failed device 75 is considered missing, it will keep its time slot in the round and if it eventually reappears, will be considered as non-missing again.

### Sub-Gigahertz Provisioning

Commissioning (provisioning) to set up the wireless control network 5 uses the commissioning network 7 that operates at a frequency of 2 Gigahertz (GHz) or above. However, here provisioning in the context of the device auto-replacement uses the wireless control network 5 that operates in the sub-gigahertz range, for example. In other words, the autonomous replacement protocol 700 is implemented in the autonomous replacement programming 380 and executes over the wireless control network 5.

As shown in the sequence diagram of FIG. 8, when the autonomous replacement protocol 700 implemented by the autonomous replacement programming 380 is triggered, a new and unprovisioned replacement device 80 starts scanning the 12 sub-gigahertz channels, looking for incoming packets. This scan process is not to be confounded with the channel assessment scan that can occur when the unprovisioned replacement device 80 is powered on. When such a packet is received, the replacement device 80 sends an unencrypted “provision me” packet to the emitter lighting control device 10A-N, 20A-N, 30, 35. Upon reception, the provisioned lighting control device 10A-N, 20A-N, 30, 35 checks whether there is a missing failed device 75 with the same product type as the replacement device 80. If this is the case, the provisioned lighting control device 10A-N, 20A-N, 30, 35 responds with an acknowledgment message.

Once the unprovisioned replacement device 80 has scanned all the channels, the replacement device 80 sends an unencrypted “provision start” packet to the best candidate, which corresponds to the responding lighting control device 10A-N, 20A-N, 30, 35 for which the highest RSSI was measured.

If no candidate lighting control device 10A-N, 20A-N, 30, 35 is found, a new scan starts. The provisioned lighting control device 10A-N, 20A-N, 30, 35 acknowledges the message and starts sending a subset of the settings, including RF parameters required to join the wireless control network 5: (1) address of the missing device; (2) last frame counter seen; (3) sub-gigahertz channel number; (4) PAN ID; (5) group ID; (6) RF power; (7) group alias; and (8) AES key used to encrypt sub-gigahertz communications over the wireless control network 5.

The unprovisioned replacement device 80 then joins the wireless control network 5 and starts querying all the remaining settings of the missing device: (1) custom user label; (2) default settings keys; (3) default settings values; (4) master settings keys; (5) global settings values; (6) preset token; and (7) trigger effects table.

Finally, provisioning of the replacement device 80 triggers a redeployment of the lighting control group table. Once the lighting control group table is deployed, all the lighting control devices are 10A-N, 20A-N, 30, 35, 80 are in the operational state and the wireless control network 5 is back on its feet.

To discover the wireless control network 5, a new replacement device 80 can implement channel scanning and send “provision me” messages. On power-up, the replacement device 80 scans all the communication channels, looking for an existing network. When a wireless control network 5 is detected (some message has been received), the replacement device 80 sends a “provision me” message to an emitter lighting control device 10A-N, 20A-N, 30, 35 of the detected message, to indicate the replacement device 80 is ready to replace a failed device 75 with the same product type. If a response is received, the emitter lighting control device 10A-N, 20A-N, 30, 35 is added to a list of potential candidates. Once all communication channels have been scanned, a “provision start” message is sent to the best candidate of the list (candidate with the best received strength signal indicator (RSSI)), which in turn triggers the provisioning process.

The peer lighting control devices 10A-N, 20A-N, 30, 35 then provision the replacement device 80. Once the replacement device 80 receives the reply to the “provision start” message referenced above, the replacement device 80 queries for a portion of the synchronized copy of settings of the failed device 75 to be transferred, particularly the RF parameters required to join the wireless control network 5. The RF parameters include: (1) sub-gigahertz address; (2) personal area network (PAN) identifier; (3) frame counter; (4) security keys. These messages can be encrypted using a pre-shared secret, defined at manufacturing.

The peer lighting control devices 10A-N, 20A-N, 30, 35 then transfer/distribute a remainder of the synchronized copy of settings of the failed device 75, including the replacement operational characteristics (e.g., settings or behaviors) to the replacement device 80. Once the replacement device 80 joins the wireless control network 5, the replacement device 80 queries and applies all settings of the failed device 75.

### Settings Synchronization

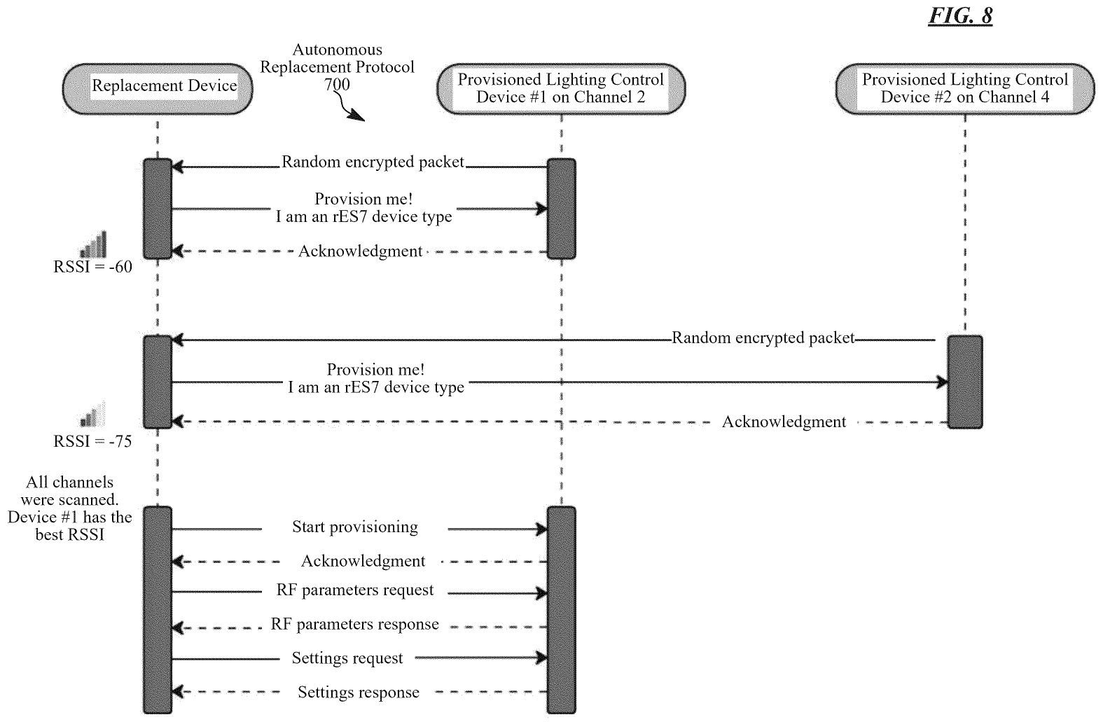

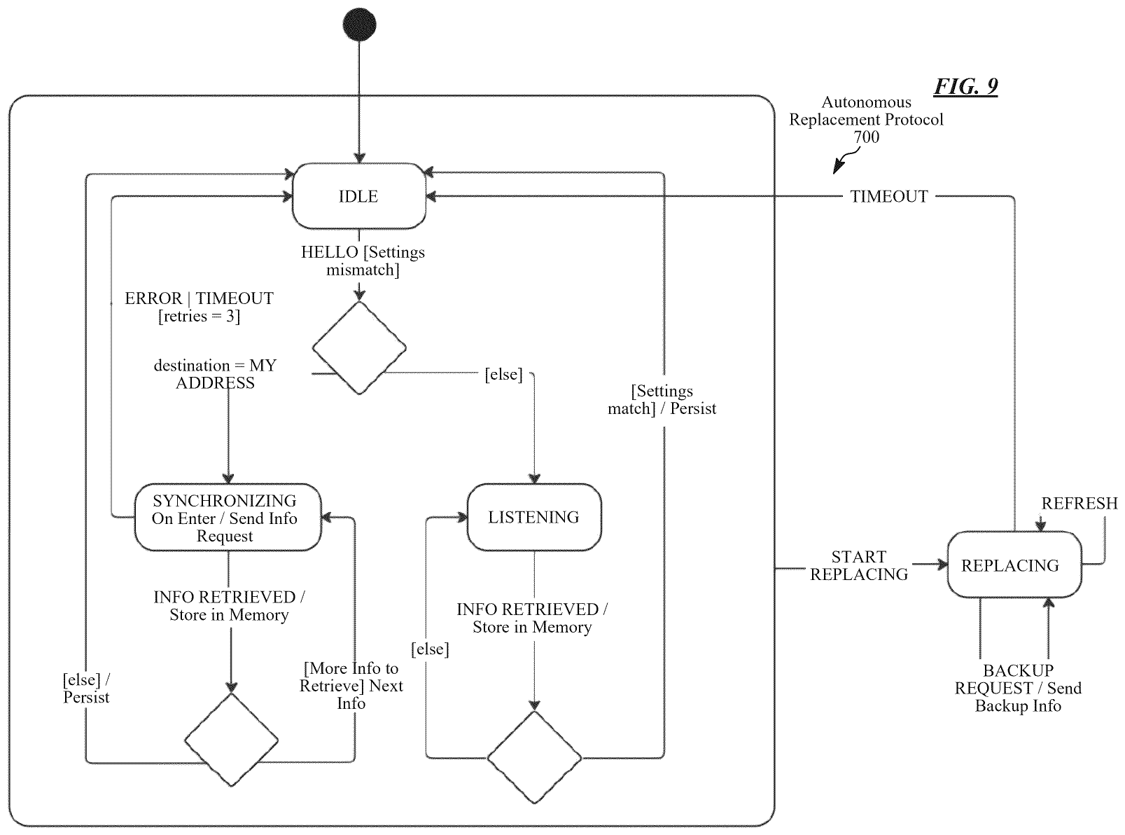

FIG. 9 is a flowchart of the settings synchronization logic of the autonomous replacement protocol 700 implemented by the autonomous replacement programming 380 in the lighting control devices 10A-N, 20A-N, 30, 35, 75. The states are defined as follows. IDLE state: nothing to do, except waiting for a HELLO event, i.e. the reception of a HELLO packet. SYNCHRONIZING state: the lighting control device is retrieving the settings of the emitter of the HELLO packet. This state is only entered if there is some mismatch between the settings or representation of the settings, such as the CRCs or hashes, of the HELLO packet and the settings or representation of the settings, such as the CRCs or hashes, calculated over our local copy of this lighting control device's settings. Only the settings category (master settings, trigger effect, etc.) for which the settings or representation of the settings, such as the CRCs or hashes, mismatch are retrieved. LISTENING state: the lighting control device is listening for the responses of the emitter lighting control device of the HELLO packet. As for the SYNCHRONIZING state, this state is only entered in case of the settings or representation of the settings, such as CRCs or hashes, mismatch. REPLACING state: while in this state, the lighting control device temporarily stops listening to other lighting control devices' HELLO packets and just waits for requests from the replacement device 80 that is being provisioned. Because the storage module only manipulates the settings of one single lighting control device at a time, this state guarantees exclusive access to the settings of the missing failed device 75.

All the states above are also part of a super state RUNNING which is only active when the lighting control device 10A-N, 20A-N, 30, 35, 75 is in the operational state, which means: (1) all security keys and RF parameters have been defined; (2) the local copy of the lighting control group table is complete; and (3) the firmware is not being updated.

When the lighting control device 10A-N, 20A-N, 30, 35, 75 is not operational, the lighting control device remains in the NOT_RUNNING state, ignoring all the events except for the START event which is triggered when the lighting control device becomes operational.

### Provisioning and Replacement

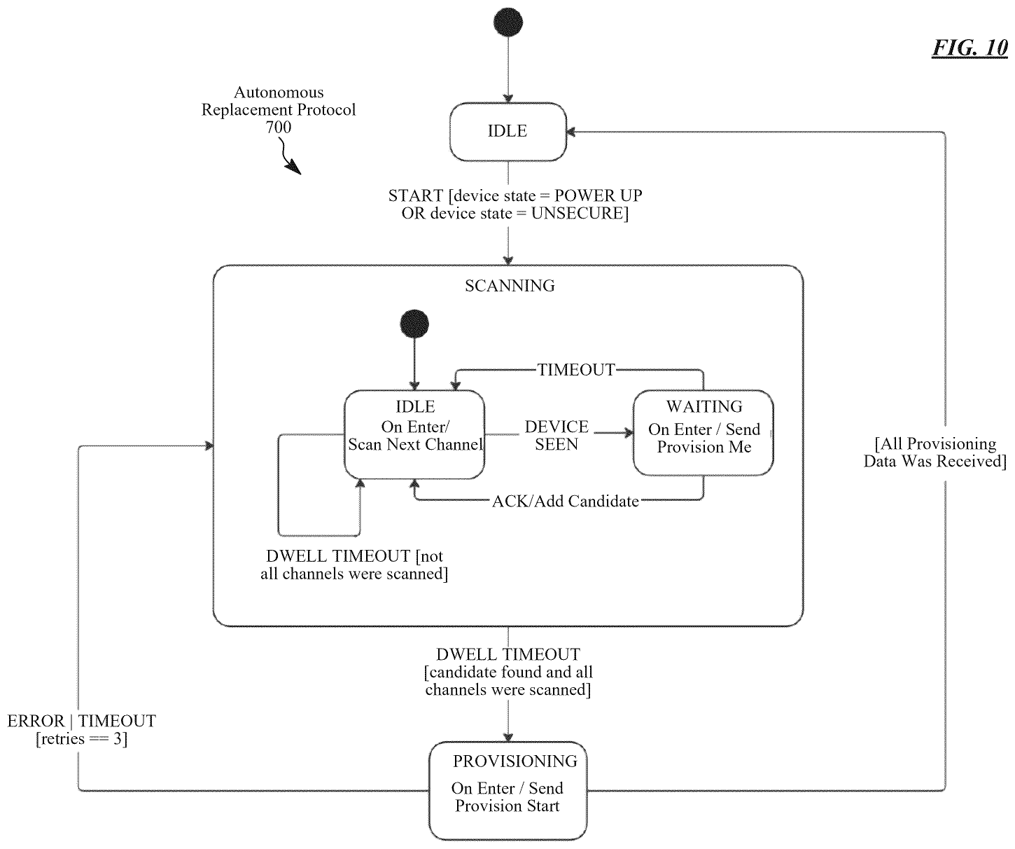

FIG. 10 depicts the provisioning and replacement logic and a corresponding flowchart of the autonomous replacement protocol 700 implemented by the autonomous replacement programming 380 in a replacement device 80.

The states are defined as follows. IDLE state: in this state, the replacement device 80 waits for an initial START event to trigger the channel scanning. SCANNING state: the replacement device 80 is actively scanning the 12 sub-gigahertz channels, looking for some random incoming message.

This SCANNING state is itself divided in two sub-states. IDLE sub-state: the replacement device 80 waits for an incoming message. If the replacement device 80 sees one, it sends a “provision me” message to the emitter lighting control device 10A-N, 20A-N, 30, 35 and enters the WAITING state. Currently, the DWELL time for each channel is 12 seconds. When all channels have been scanned, if some provisioned lighting control device 10A-N, 20A-N, 30, 35 acknowledges the “provision me,” the replacement device 80 enters the PROVISIONING state. WAITING sub-state: the replacement device 80 waits for an ACK for the “provision me” message. If none is received after a certain amount of time, the replacement device 80 gets back to the IDLE sub-state.

PROVISIONING state: this is where the actual provisioning happens. The process is driven by the replacement device 80, which starts by sending a “provision start” message. On the other end, the provisioned lighting control device 10A-N, 20A-N, 30, 35 enters the “REPLACING” state of FIG. 9 referenced in setting synchronization and starts servicing requests of the replacement device 80. The PROVISIONING state is itself composed of several sequential sub-states for all the kinds of information that need to be fetched:

STARTING sub-state: unsecure communication. The replacement device 80 waits for the “provision start” ACK that contains the sub-gigahertz address, the PAN ID, lighting control group ID on the wireless control network 5, and group alias.

SUBG_KEY sub-state: unsecure communication. Waiting for the AES key used for encryption of the sub-gigahertz communication over the wireless control network 5.

SITE sub-state: With the AES key received in the previous state, the communication can now be secured from now on. Waiting for the site AES key and GUID.

KEY_X sub-state: X coordinate of the site public key.

KEY_Y sub-state: Y coordinate of the site public key.

SETTINGS sub-state: all the settings, including custom user label, default, master, global, preset tokens, and trigger effect table.

GROUP_TABLE sub-state: upon entering the state, the replacement device 80 sends a message to trigger a redeployment of the lighting control group table and waits for an ACK. When the ACK is received, the replacement device 80 gets back to the IDLE state while the lighting control group table is being deployed. Once the lighting control group table is deployed, the replacement device 80 becomes operational.

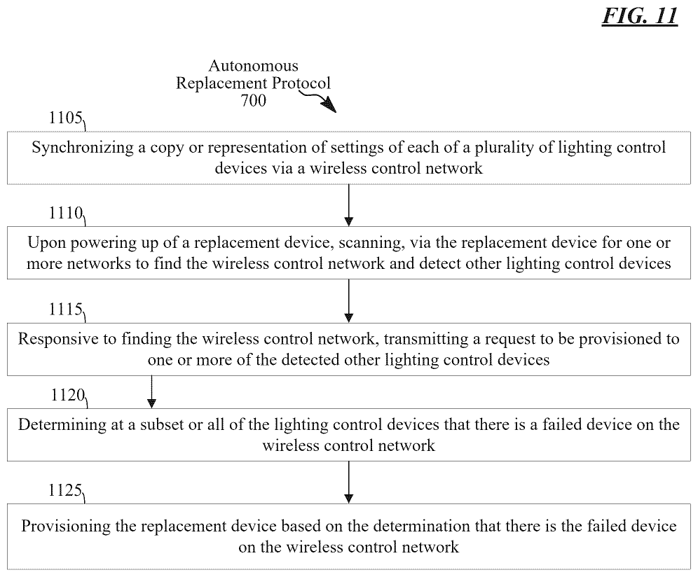

FIG. 11 is an autonomous replacement protocol 700 procedure for the lighting control system 1 of FIGS. 1-2.

Beginning in block 1105, execution of the autonomous replacement programming 380 configures one or more computing devices 10A-N, 20A-N, 30, 35, 75, 80 to synchronize a copy or representation of settings of each of a plurality of lighting control devices 10A-N, 20A-N, 30, 35 via a wireless control network 5. The synchronized copy or representation of settings can include a network address, a device type, device settings, a frame counter for each of the plurality of lighting control devices 10A-N, 20A-N, 30, 35, a combination thereof, or a representative code or value thereof.

Moving to block 1110, execution of the autonomous replacement programming 380 configures one or more computing devices 10A-N, 20A-N, 30, 35, 75, 80 to upon powering up of a replacement device 80, scan, via the replacement device 80 for one or more networks 5 to find the wireless control network 5 and detect other lighting control devices 10A-N, 20A-N, 30, 35.

Proceeding now to block 1115, execution of the autonomous replacement programming 380 configures one or more computing devices 10A-N, 20A-N, 30, 35, 75, 80 to responsive to finding the wireless control network 5, transmit a request to be provisioned to one or more of the detected other lighting control devices 10A-N, 20A-N, 30, 35.

Continuing now to block 1120, execution of the autonomous replacement programming 380 configures one or more computing devices 10A-N, 20A-N, 30, 35, 75, 80 to determine at a subset or all of the lighting control devices 10A-N, 20A-N, 30, 35 that there is a failed device 75 on the wireless control network 5. The determining at the subset or all of the lighting control devices 10A-N, 20A-N, 30, 35 that there is the failed device 75 on the wireless control network 5 can include the following. First, after synchronizing the copy or representation of settings of each of the plurality of lighting control devices 10A-N, 20A-N, 30, 35 via the wireless control network 5, sending a respective message from each respective lighting control device 10A-N, 20A-N, 30, 35 to peer lighting control devices 10A-N, 20A-N, 30, 35 periodically at an assigned time slot in a number of rounds. The respective message can include a list of the peer lighting control devices 10A-N, 20A-N, 30, 35 the respective lighting control device 10A-N, 20A-N, 30, 35 considers offline. Second, after the number of rounds, responsive to the peer lighting control devices 10A-N, 20A-N, 30, 35 on the wireless control network 5 achieving a consensus that considers a particular lighting control device to be offline in the list, determining that the particular lighting control device is the failed device 75. The peer lighting control devices 10A-N, 20A-N, 30, 35 can form a lighting control group and the consensus can be achieved at a level of the lighting control group.

Finishing now in block 1125, execution of the autonomous replacement programming 380 configures one or more computing devices 10A-N, 20A-N, 30, 35, 75, 80 to provision the replacement device 80 based on the determination that there is the failed device 75 on the wireless control network 5. The provisioning the replacement device 80 based on the determination that there is the failed device 75 on the wireless control network 5 can include the following. First, verifying the replacement device 80 is of a same device type as the failed device 75. Second, enabling the replacement device 80 to join the wireless control network 5. Third, transferring the synchronized copy or representation of settings of the failed device 75 to the replacement device 80. Fourth, loading the synchronized copy or representation of the settings of the failed device 75 on the replacement device 80. The provisioning the replacement device 80 based on the determination that there is the failed device 75 on the wireless control network 5 can further include: confirming that the replacement device 80 operates as the failed device 75 by flashing an illumination pattern on the replacement device 80.

The provisioning the replacement device 80 based on the determination that there is the failed device 75 on the wireless control network 5 can be performed on the wireless control network 5. The plurality lighting control devices 10A-N, 20A-N, 30, 35 can be previously commissioned on a separate commissioning network 7 via a commissioning/maintenance application 22 on a mobile device 25.

The provisioning the replacement device 80 based on the determination that there is the failed device 75 on the wireless control network 5 can include the following. First, enabling the replacement device 80 to join the wireless control network 5. Second, transferring the copy or representation of settings of the failed device 75 to the replacement device 80. Third, loading the copy or representation of the settings of the failed device 75 on the replacement device 80.

In the examples above, the luminaires 10A-N, wall switches 20A-N, mobile device 25, plug load controller 30, power pack 35, failed device 75, replacement device 80, etc. each include a network communication interface 345, 350, 445, 450, 545, 550, 645, 650, for wired or wireless communication over one or more networks 5, 7. For example, the network communication interface can be a dual-band wireless radio communication interface system that includes a sub-gigahertz band radio transceiver 345 for wireless communication over the first wireless communication band of the wireless control network 5; and a two gigahertz or higher band radio transceiver 350 for wireless communication over the second wireless communication band of a commissioning network 7. Of course, any suitable RF communication bands can be used.

The networks 5, 7 interconnect the links to/from the network communication interfaces 345, 350, 445, 450, 545, 550, 645, 650 of the devices, so as to provide data communications amongst the luminaires 10A-N, wall switches 20A-N, mobile device 25, plug load controller 30, power pack 35, failed device 75, replacement device 80, etc. Networks 5, 7 may support data communication by equipment at the premises via wired (e.g., cable or fiber) media or via wireless (e.g., Wi-Fi, Bluetooth™, ZigBee, LiFi, IrDA, etc.) or combinations of wired and wireless technology.

Any of the functionality of the autonomous replacement protocol 700, including autonomous replacement programming 380, described herein for the luminaires 10A-N, wall switches 20A-N, mobile device 25, plug load controller 30, power pack 35, failed device 75, replacement device 80, etc. can be embodied in one or more applications or firmware as described previously. According to some embodiments, “function,” “functions,” “application,” “applications,” “instruction,” “instructions,” or “programming” are program(s) that execute functions defined in the programs. Various programming languages can be employed to create one or more of the applications, structured in a variety of manners, such as object-oriented programming languages (e.g., Objective-C, Java, or C++) or procedural programming languages (e.g., C or assembly language).

In the examples above, the luminaires 10A-N, wall switches 20A-N, mobile device 25, plug load controller 30, power pack 35, failed device 75, replacement device 80, etc. can each include a processor. As used herein, a processor 323, 423, 523, 623 is a hardware circuit having elements structured and arranged to perform one or more processing functions, typically various data processing functions. Although discrete logic components could be used, the examples utilize components forming a programmable central processing unit (CPU). A processor 323, 423, 523, 623 for example includes or is part of one or more integrated circuit (IC) chips incorporating the electronic elements to perform the functions of the CPU. The processors 323, 423, 523, 623 for example, may be based on any known or available microprocessor architecture, such as a Reduced Instruction Set Computing (RISC) using an ARM architecture. Of course, other processor circuitry may be used to form the CPU or processor hardware in. The illustrated examples of the processors 323, 423, 523, 623 can include one microprocessor or a multi-processor architecture. A digital signal processor (DSP) or field-programmable gate array (FPGA) could be suitable replacements for the processors 323, 423, 523, 623, but may consume more power with added complexity.

The applicable processor 323, 423, 523, 623 executes programming or instructions to configure the luminaires 10A-N, wall switches 20A-N, mobile device 25, plug load controller 30, power pack 35, failed device 75, replacement device 80, etc. to perform various operations. For example, such operations may include various general operations (e.g., a clock function, recording and logging operational status and/or failure information) as well as various system-specific operations (e.g., energy management) functions. Although a processor 323, 423, 523, 623 may be configured by use of hardwired logic, typical processors are general processing circuits configured by execution of programming, e.g., instructions and any associated setting data from the memories 322, 422, 522, 622 shown or from other included storage media and/or received from remote storage media.

In the examples above, the luminaires 10A-N, wall switches 20A-N, mobile device 25, plug load controller 30, power pack 35, failed device 75, replacement device 80, etc. each include a memory. The memory 322, 422, 522, 622 may include a flash memory (non-volatile or persistent storage), a read-only memory (ROM), and a random access memory (RAM) (volatile storage). The RAM serves as short term storage for instructions and data being handled by the processors 323, 423, 523, 623, e.g., as a working data processing memory. The flash memory typically provides longer term storage.

Of course, other storage devices or configurations may be added to or substituted for those in the example. Such other storage devices may be implemented using any type of storage medium having computer or processor readable instructions or programming stored therein and may include, for example, any or all of the tangible memory of the computers, processors or the like, or associated modules.

Hence, a machine-readable medium or a computer-readable medium may take many forms of tangible storage medium. Non-volatile storage media include, for example, optical or magnetic disks, such as any of the storage devices in any computer(s) or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards, paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

According to exemplary embodiments of the present disclosure the one or more processors and control circuits can include one or more of any known general purpose processor or integrated circuit such as a central processing unit (CPU), microprocessor, field programmable gate array (FPGA), Application Specific Integrated Circuit (ASIC), Digital Signal Processor (DSP), or other suitable programmable processing or computing device or circuit as desired that is specially programmed to perform operations for achieving the results of the exemplar embodiments described herein. The processor(s) can be configured to include and perform features of the exemplary embodiments of the present disclosure, such as the autonomous replacement protocol 700 and the autonomous replacement programming 380. The features can be performed through program code encoded or recorded on the processor(s), or stored in a non-volatile memory device, such as Read-Only Memory (ROM), erasable programmable read-only memory (EPROM), or other suitable memory device or circuit as desired. Accordingly, such computer programs can represent controllers of the computing device.

In another exemplary embodiment, the program code, such as the autonomous replacement protocol 700 and the autonomous replacement programming 380, can be provided in a computer program product having a non-transitory computer readable medium, such as Magnetic Storage Media (e.g. hard disks, floppy discs, or magnetic tape), optical media (e.g., any type of compact disc (CD), or any type of digital video disc (DVD), or other compatible non-volatile memory device as desired) and downloaded to the processor(s) for execution as desired, when the non-transitory computer readable medium is placed in communicable contact with the processor(s).

The one or more processors 323, 423, 523, 623 can be included in a computing system that is configured with components such as memory, a hard drive, an input/output (I/O) interface, a communication interface, a display and any other suitable component as desired. The exemplary computing device can also include a communications interface. The communications interface can be configured to allow software and data to be transferred between the computing device and external devices. Exemplary communications interfaces can include a modem, a network interface (e.g., an Ethernet card), a communications port, a PCMCIA slot and card, or any other suitable network communication interface as desired. Software and data transferred via the communications interface can be in the form of signals, which can be electronic, electromagnetic, optical, or other signals as will be apparent to persons having skill in the relevant art. The signals can travel via a communications path, which can be configured to carry the signals and can be implemented using wire, cable, fiber optics, a phone line, a cellular phone link, a radio frequency link, or any other suitable communication link as desired.

Where the present disclosure is implemented using programming or software, including the autonomous replacement protocol 700 and the autonomous replacement programming 380, the programming or software can be stored in a computer program product or non-transitory computer readable medium and loaded into the computing device using a removable storage drive or communications interface. In an exemplary embodiment, any computing device, such as luminaires 10A-N, wall switches 20A-N, mobile device 25, plug load controller 30, power pack 35, failed device 75, replacement device 80, disclosed herein can also include a display interface that outputs display signals to a display unit, e.g., LCD screen, plasma screen, LED screen, DLP screen, CRT screen, or any other suitable graphical interface as desired.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” “has,” “having,” “containing,” “contain”, “contains,” “with,” “formed of,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element. Unless otherwise stated, the articles “a” or “an” preceding an element mean one or more of the elements.

Unless otherwise stated, any and all measurements, values, ratings, positions, magnitudes, sizes, angles, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±5% or as much as ±10% from the stated amount. The terms “approximately” and “substantially” mean that the parameter value or the like varies up to ±10% from the stated amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

What is claimed is:

1. A non-transitory computer-readable medium, comprising autonomous replacement programming, wherein execution of the autonomous replacement programming by one or more processors configures one or more computing devices to:
synchronize a copy or representation of settings of each of a plurality of lighting control devices via a wireless control network;
upon powering up of a replacement device, scan, via the replacement device for one or more networks to find the wireless control network and detect other lighting control devices;
responsive to finding the wireless control network, transmit a request to be provisioned to one or more of the detected other lighting control devices;
determine at a subset or all of the lighting control devices that there is a failed device on the wireless control network; and
provision the replacement device based on the determination that there is the failed device on the wireless control network.

2. The non-transitory computer-readable medium of claim 1, wherein the provisioning the replacement device based on the determination that there is the failed device on the wireless control network includes:
verifying the replacement device is of a same device type as the failed device;
enabling the replacement device to join the wireless control network;
transferring the synchronized copy or representation of settings of the failed device to the replacement device; and
loading the synchronized copy or representation of the settings of the failed device on the replacement device.

3. The non-transitory computer-readable medium of claim 2, wherein the provisioning the replacement device based on the determination that there is the failed device on the wireless control network further includes:
confirming that the replacement device operates as the failed device by flashing an illumination pattern on the replacement device.

4. The non-transitory computer-readable medium of claim 1, wherein the determining at the subset or all of the lighting control devices that there is the failed device on the wireless control network includes:
after synchronizing the copy or representation of settings of each of the plurality of lighting control devices via the wireless control network, sending a respective message from each respective lighting control device to peer lighting control devices periodically at an assigned time slot in a number of rounds, the respective message including a list of the peer lighting control devices the respective lighting control device considers offline; and
after the number of rounds, responsive to the peer lighting control devices on the wireless control network achieving a consensus that considers a particular lighting control device to be offline in the list, determining that the particular lighting control device is the failed device.

5. The non-transitory computer-readable medium of claim 4, wherein the peer lighting control devices form a lighting control group and the consensus is achieved at a level of the lighting control group.

6. The non-transitory computer-readable medium of claim 1, wherein:
the provisioning the replacement device based on the determination that there is the failed device on the wireless control network is performed on the wireless control network; and
the plurality lighting control devices were previously commissioned on a separate commissioning network via a commissioning/maintenance application on a mobile device.

7. The non-transitory computer-readable medium of claim 1, wherein the provisioning the replacement device based on the determination that there is the failed device on the wireless control network includes:
enabling the replacement device to join the wireless control network;
transferring the copy or representation of settings of the failed device to the replacement device; and
loading the copy or representation of the settings of the failed device on the replacement device.

8. The non-transitory computer-readable medium of claim 1, wherein the synchronized copy or representation of settings include a network address, a device type, device settings, a frame counter for each of the plurality of lighting control devices, a combination thereof, or a representative code or value thereof.

9. A method, comprising:
synchronizing a copy or representation of settings of each of a plurality of lighting control devices via a wireless control network;
upon powering up of a replacement device, scanning, via the replacement device for one or more networks to find the wireless control network and detect other lighting control devices;
responsive to finding the wireless control network, transmitting a request to be provisioned to one or more of the detected other lighting control devices;
determining at a subset or all of the lighting control devices that there is a failed device on the wireless control network; and
provisioning the replacement device based on the determination that there is the failed device on the wireless control network.

10. The method of claim 9, wherein the provisioning the replacement device based on the determination that there is the failed device on the wireless control network includes:
verifying the replacement device is of a same device type as the failed device;
enabling the replacement device to join the wireless control network;
transferring the synchronized copy or representation of settings of the failed device to the replacement device; and
loading the synchronized copy or representation of the settings of the failed device on the replacement device.

11. The method of claim 10, wherein the provisioning the replacement device based on the determination that there is the failed device on the wireless control network further includes:
confirming that the replacement device operates as the failed device by flashing an illumination pattern on the replacement device.

12. The method of claim 9, wherein the determining at the subset or all of the lighting control devices that there is the failed device on the wireless control network includes:
after synchronizing the copy or representation of settings of each of the plurality of lighting control devices via the wireless control network, sending a respective message from each respective lighting control device to peer lighting control devices periodically at an assigned time slot in a number of rounds, the respective message including a list of the peer lighting control devices the respective lighting control device considers offline; and
after the number of rounds, responsive to the peer lighting control devices on the wireless control network achieving a consensus that considers a particular lighting control device to be offline in the list, determining that the particular lighting control device is the failed device.

13. The method of claim 12, wherein the peer lighting control devices form a lighting control group and the consensus is achieved at a level of the lighting control group.

14. The method of claim 9, wherein:
the provisioning the replacement device based on the determination that there is the failed device on the wireless control network is performed on the wireless control network; and
the plurality lighting control devices were previously commissioned on a separate commissioning network via a commissioning/maintenance application on a mobile device.

15. The method of claim 9, wherein the provisioning the replacement device based on the determination that there is the failed device on the wireless control network includes:
enabling the replacement device to join the wireless control network;
transferring the copy or representation of settings of the failed device to the replacement device; and
loading the copy or representation of the settings of the failed device on the replacement device.

16. The method of claim 9, wherein the synchronized copy or representation of settings include a network address, a device type, device settings, a frame counter for each of the plurality of lighting control devices, a combination thereof, or a representative code or value thereof.

17. A lighting control system, comprising:
a plurality of lighting control devices, including a plurality of luminaires, each respective one of the luminaires comprising:
a light source;
a driver circuit coupled to the light source;
a processor coupled to the driver circuit and configured to control light source operation via the driver circuit;
a dual-band wireless radio communication interface system configured for wireless communication:
via a wireless control network, over a first of two different wireless communication bands, of light source control operations over the first wireless communication band; and
via a commissioning network with a mobile commissioning/maintenance application on a mobile device, over a second of the two different wireless communication bands, of commissioning operations for the respective luminaire;
a memory accessible to the processor; and
programming in the memory which configures the processor to:
synchronize a copy or representation of settings of each of the lighting control devices via the wireless control network;
upon powering up of a replacement device, scan, via the replacement device for one or more networks to find the wireless control network and detect other lighting control devices;
responsive to finding the wireless control network, transmit a request to be provisioned to one or more of the detected other lighting control devices;
determine at a subset or all of the lighting control devices that there is a failed device on the wireless control network; and
provision the replacement device based on the determination that there is the failed device on the wireless control network.

18. The lighting control system of claim 17, wherein the provisioning the replacement device based on the determination that there is the failed device on the wireless control network includes:
verifying the replacement device is of a same device type as the failed device;
enabling the replacement device to join the wireless control network;
transferring the synchronized copy or representation of settings of the failed device to the replacement device; and
loading the synchronized copy or representation of the settings of the failed device on the replacement device.

19. The lighting control system of claim 18, wherein the provisioning the replacement device based on the determination that there is the failed device on the wireless control network further includes:
confirming that the replacement device operates as the failed device by flashing an illumination pattern on the replacement device.

20. The lighting control system of claim 17, wherein each dual-band wireless radio communication interface system comprises:
a sub-gigahertz band radio transceiver for wireless communication over the first wireless communication band; and
a two gigahertz or higher band radio transceiver for wireless communication over the second wireless communication band.
